(19) United States
(12) Patent Application Publication
(10) Pub. No.: US 2009/0163168 A1
(43) Pub. Date: Jun. 25, 2009

(54) EFFICIENT INITIALIZATION OF ITERATIVE PARAMETER ESTIMATION

(75) Inventors: Soren Vang Andersen, Aalborg (DK); Chunjian Li, Aalborg (DK)

Correspondence Address: BIRCH STEWART KOLASCH & BIRCH, PO BOX 747, FALLS CHURCH, VA, 22040-0747, US

(73) Assignee: Aalborg Universitet, Aalborg (DK)

(21) Appl. No.: 11/912,571

(22) PCT Filed: Apr. 26, 2006
(86) PCT No.: PCT/DK2006/000222

§ 371 Date: Aug. 1, 2008

(30) Foreign Application Priority Data
Apr. 26, 2005 (DK) PA 2005 00603
Apr. 26, 2005 (DK) PA 2005 00604

(51) Int. Cl. H04B 1/10

(52) U.S. Cl. 455/307

(57) ABSTRACT

The invention provides a method to initialize an iterative signal estimation algorithm, such as an expectation-maximization type algorithm, the method including the step of performing a non-parametric noise reduction method. Preferably, the non-parametric noise reduction method includes performing a spectral subtraction such as a power spectral subtraction and more preferably a weighted power spectral subtraction. Method according to any of the preceding claims, wherein the iterative signal estimation algorithm includes performing an expectation-maximization algorithm. Especially, the initialization may be used for an iterative signal estimation algorithm that includes performing a prediction error Kalman filtering followed by a local variance estimation. Preferably, the iterative signal estimation algorithm includes performing a signal estimation step including a Kalman filtering, and the iterations in the iterative signal estimation algorithm are preferably performed inter-frame sequentially. The invention also provides a noise reduction method based on performing the initialization method and an iterative signal estimation algorithm thus providing a noise suppressed signal. In addition, the methods may form part of a speech enhancement for enhancing speech in a noisy signal. In addition, the invention provides a device such as a headset, a hearing aid, or a mobile phone including a processor adapted to perform the described methods.

### FIELD OF THE INVENTION

The invention relates to the field of signal processing, more specifically to processing aiming at noise reduction, e.g. with the purpose of enhancing speech contained in a noisy signal. The invention provides a method and a device, e.g. a headset, adapted to perform the method.

### BACKGROUND OF THE INVENTION

Single channel iterative parameter estimation algorithms are well-known for noise reduction purposes, i.e. processing of a noisy signal with the purpose of suppressing the noise. E.g. such algorithms can be used for use speech enhancement, e.g. to improve speech intelligibility of speech contained in noise, e.g. for application in hearing aids and telephony equipments. Such iterative methods may be of the expectation-maximization (EM) type, e.g. based on Wiener filtering or Kalman filtering.

The success of such algorithms, i.e. fast convergence, depends not only on the iterative parameter estimation algorithm itself but also on the initialization step preceding the algorithm. Thus, in order to obtain a rapid convergence of EM methods, and thus achieve a computationally effective noise reduction method, it is crucial to have an efficient pre-processing providing a qualified initial estimate of parameters as starting point for the subsequent iterations of EM algorithms.

In “Algorithms for single microphone speech enhancement”, M.Sc. Thesis, Tel-Aviv University, April 1995 by S. Gannot, initialization of an iterative parameter estimation is proposed. Higher order statistics is used in the first estimation of auto-regressive parameters in order to improve the immunity to Gaussian noise.

In “Kalman filtering speech enhancement method based on voiced-unvoiced speech model”, IEEE Trans. on Speech and Audio Processing, vol. 7, No. 5, pp. 510-524, 1999, by Z. Goth, K. Tan, and B. T. G. Tan, a simple initialization step is proposed. A smoothing of the spectrum of the noisy signal is performed before the first step of the iterative algorithm.

Still, it remains as a goal to improve efficiency of iterative signal estimation algorithms in order to be able to achieve a high noise suppression ratio at a low amount of iterations, preferably hereby making iterative estimation algorithms so computational efficient that allows the methods to be implemented in devices with limited signal processing power, e.g. hearing aids, mobile phones, headsets and the like, where the methods can be used for on-line noise reduction, e.g. speech enhancement.

### SUMMARY OF THE INVENTION

Thus, it may be seen as an object of the present invention to provide an efficient iterative signal estimation algorithm, especially an initialization, or pre-processing, preceding such algorithm to improve its convergence speed, i.e. save the necessary amount of iterations required to obtain a given noise suppression.

In a first aspect, the invention provides a method to initialize an iterative signal estimation algorithm, the method including the step of performing a non-parametric noise reduction method.

By initializing an iterative signal estimation algorithm, e.g. an EM based algorithm, by providing a pre-processing including performing a non-parametric noise reduction method, an efficient starting point for the Iterative algorithm is obtained thus leading to a fast convergence of the algorithm. Hereby, the overall computational efficiency of the algorithm can be improved.

In preferred embodiments, the non-parametric noise reduction method includes performing a spectral subtraction, such as a power spectral subtraction, and more preferably a weighted power spectral subtraction. Such initialization including a weighted power spectral subtraction including a weighted combination of signal power spectrum estimated in a previous frame and the signal power spectrum estimated in the current frame. Thus, the iteration of the current frame is started with the result of the previous iteration as well as the new information in the current frame. Preferably, the weight of the previous frame is set much larger than the weight of the current frame.

In the following a preferred iterative signal estimation algorithm is defined. This algorithm is especially suited for the described Initialization, however it is appreciated that the algorithm may be used with or without the described initialization.

The preferred iterative signal estimation algorithm includes performing an expectation-maximization (EM) algorithm. Preferably, the algorithm includes performing a prediction error Kalman filtering. Preferably, the algorithm includes performing a local variance estimation, and more preferably the prediction error Kalman filtering is followed by the local variance estimation. Preferably, the iterative signal estimation algorithm includes performing a signal estimation step including a Kalman filtering. Preferably, iterations in the iterative signal estimation algorithm are performed inter-frame sequentially.

In a second aspect, the Invention provides a noise reduction method including
performing the method according to any of the embodiments of the first aspect,
performing the iterative signal estimation algorithm, and
providing a noise suppressed signal based on an output from the iterative signal estimation-algorithm.

Thus, the noise reduction method of the second aspect have the same advantages as mentioned for the first aspect, and it is understood that the preferred embodiments described for the first aspect apply for the second aspect as well.

The method is suited for a number of purposes where it is desired to perform a reduction of noise of a noisy signal, in general the method is suited to reduce noise by processing a noisy signal, i.e. an Information signal corrupted by noise, and returning a noise suppressed signal. The signal may in general represent any type of data, e.g. audio data, image data, control signal data, data representing measured values etc. or any combination thereof. Due to the computational efficiency, the method is suited for on-line applications where limited signal processing power is available.

In a third aspect, the Invention provides a speech enhancement method Including performing the noise reduction method of the second aspect on a noisy signal containing speech so as to enhance the speech.

Thus, being based on the first and second aspects, the speech enhancement method of the third aspect have the same advantages as mentioned for the first and second aspects, and the preferred embodiments mentioned for the first aspect therefore also apply.

The speech enhancement method is suited for application where a noisy audio signal containing speech is corrupted by noise. The noise may be caused by electrical noise interfering with an electrical audio signal, or the noise may be acoustic noise such as introduced at the recording of the speech, e.g. a person speaking in a telephone at a place with traffic noise etc. The speech enhancement method can then be used to increase speech intelligibility by enhancing the speech in relation to the noise.

In a fourth aspect the invention provides a device including a processor adapted to perform the method of any one of the first, second or third aspects. Thus, the advantages and embodiments mentioned for the first, second and third aspects therefore apply for the fourth aspect as well. Due to the computational efficiency of the proposed methods, the signal processing power of the processor is relaxed.

Especially, the device may be: a mobile phone, a radio communication device, an internet telephony system, sound recording equipment, sound processing equipment, sound editing equipment, broadcasting sound equipment, or a monitoring system.

Alternatively, the device may be: a hearing aid, a headset, an assistive listening device, an electronic hearing protector, or a headphone with a built-in microphone (so as to allow sound from the environments to reach the listener).

In a fifth aspect, the Invention provides a computer executable program code adapted to perform the method according to any one of the first, second or third aspects. Thus, the same advantages as mentioned for these aspects therefore apply.

The program code may be present on a program carrier, e.g. a memory card, a disk etc. or in a RAM or ROM memory of a device.

### BRIEF DESCRIPTION OF THE DRAWINGS

In the following the Invention is described in more details with reference to the accompanying figures, of which

FIG. 1 illustrates a block diagram of a preferred Iterative signal estimation algorithm including a preferred initialization step,

FIG. 2 illustrates another preferred algorithm without (A) and with (B) a preferred initialization step, and

FIG. 3 illustrates a preferred device.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF PREFERRED EMBODIMENTS

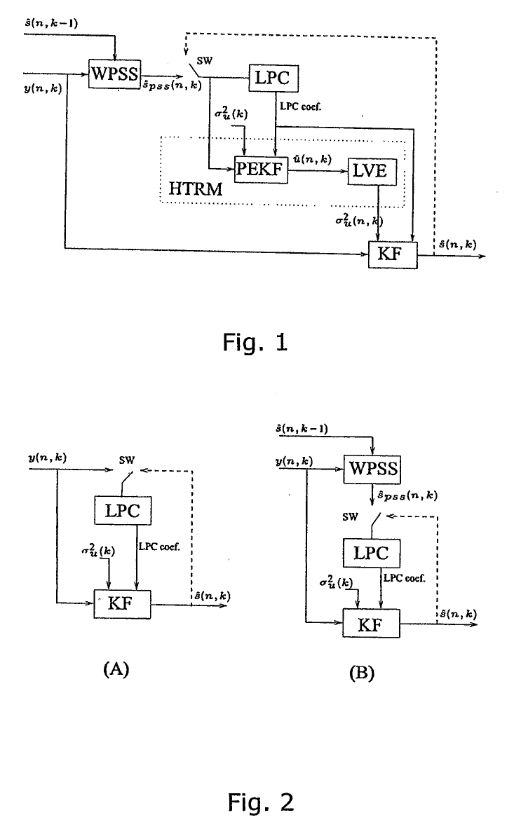

In the following specific embodiments of the first aspect of the invention are illustrated referring to FIGS. 1 and 2. The embodiments are speech enhancement schemes that can be seen as approximations to the expectation-maximization (EM) algorithm. The embodiments employ a Kalman filter that models the excitation source as a spectrally white process with a rapidly time-varying variance, which calls for a high temporal resolution estimation of this variance. A local variance estimator based on a prediction error Kalman filter is designed for this high temporal resolution variance estimation. The initialization procedure introduced is a weighted power spectral subtraction filter that leads to a fast convergence and avoidance of local maxima of the likelihood function. Iterations are made sequential inter-frame, exploiting the fact that the auto-regressive model changes slowly between neighbouring frames. The described algorithm is computationally more efficient than a baseline EM algorithm due to its fast convergence. Performance comparison show significant improvement over the baseline EM algorithm in terms of three objective measures. Listening tests indicate that the algorithm implies a significant reduction of musical noise compared to the baseline EM algorithm.

Single channel noise reduction of speech signals using iterative estimation methods has been an active research area for the last two decades. Most of the known iterative speech enhancement schemes are based on, or can be interpreted as, the Expectation-Maximization (EM) algorithm or a certain approximation to it. Proposals of the EM algorithms for speech enhancement can be found in [2] [15] [8] [3] [4]. Some other iterative speech enhancement techniques can be seen as approximations to the EM algorithm, see e.g. [12] [7] [5] [6]. A paradigm of these EM based approaches is to iterate between an expectation step comprising Wiener or Kalman filtering given the current estimate of signal model parameters, and a maximization step comprising the estimation of the parameters given the filtered signal. By doing so, the conditional likelihood of the estimated parameters and the signal increases monotonically until a certain convergence criterion is reached.

Evolution of these EM approaches is seen in the underlying signal models. In early proposals [12] [2] [7], the non-causal IIR Wiener filter (WF) is used, where the signal is modeled as a short-time stationary Gaussian process. This is a rather simplified model, where the speech is assumed to be stationary and the voiced and unvoiced speech share the same Gaussian model even though voiced speech is known to be far from Gaussian. The time domain formulation in [15] uses the Kalman smoother in place of the WF, which allows the signal to be modeled as non-stationary but still uses one model for both voiced and unvoiced speech. In [8], the speech excitation source is modeled as a mixture of two Gaussian processes with differing variances. For voiced speech, the process with higher variance models the impulses and the one with lower variance models the rest of the excitation sequence. The detection of the impulse is done by a likelihood test at every time instant. In [3], an explicit model of speech production is used, where the excitation of voiced speech is modeled as an impulse train superimposed in white noise. The impulse parameters (pitch period, amplitude, and phase) and the noise floor variance are estimated iteratively by an inner loop in every iteration. In [6], the long term correlation in voiced speech is explicitly modeled. To accomplish this, the instantaneous pitch period and the degree of voicing need to be estimated in every frame. In general, using finer models has the potential to improve the enhanced speech quality, but also raises the concern of complexity and robustness, since the decision on voicing and other pitch related parameters are difficult to extract from noisy observations.

Another line of development in speech enhancement employing fine models of the voiced speech production mechanism puts effort into modeling the rapidly varying variance of the excitation source of voiced speech signals under a Linear Minimum Mean Squared-Error Estimator (LMMSE) framework [10] [11] [9]. It is shown that the prominent temporal localization of power in the excitation source of voiced speech is a major source of correlation between spectral components of the signal. An LMMSE estimator with a signal model that models this non-stationarity can achieve both higher SNR gain and lower spectral distortion. It is well known that the Kalman filter provides a more convenient framework for modeling signal non-stationarity than the WF: the WF assumes the signal to be wide-sense stationary; while the Kalman filter allows for a dynamic mean, which is modeled by the state transition model, and a dynamic system noise variance, which is assumed to be known a priori. Whereas, in most of the proposed Kalman filtering based speech enhancement approaches, the system noise variance is modeled as constant within a short frame, thus an important part of the non-stationarity is not modeled. In [9], the temporal localization of power in the excitation source is estimated by a modified Multi-pulse LPC method, and the Kalman filter using this dynamic system noise variance gives promising results.

In this paper, we propose a new iterative approach employing Kalman filtering with a signal model comprising a rapidly time-varying excitation variance. The proposed algorithm consists of three steps in every iteration, i.e., the estimation of the auto-regressive (AR) parameters, the excitation source variance estimation with high temporal resolution, and the Kalman filtering. The high temporal resolution estimation of the excitation variance is performed by a combination of a prediction-error Kalman filter and a spline smoothing method. By employing an initialization procedure called Weighted Spectral Power Subtraction, the convergence is achieved in one iteration per frame. The iterative scheme thus becomes frame-wise sequential, because the estimation in the current frame is based on the filtered signal of the previous frame. In contrast with the aforementioned EM approaches with fine speech production models, this approach has the advantages of simplicity and robustness since it requires no explicit estimation of pitch related parameters neither voiced/unvoiced decisions. The low computational complexity is also attributed to its fast convergence.

The Kalman Filter Based Iterative Scheme

It is convenient to introduce the overall scheme before going into detailed discussion.

FIG. 1 shows the function blocks of the proposed algorithm. The noisy signal is segmented into non-overlapping short analysis frames. We denote the nth sample of the speech signal, the additive noise, and the noisy observation of the kth frame as s(n, k), v(n, k) and y(n, k), respectively. At the first iteration of the kth frame, the noisy signal is first filtered by a Weighted Power Spectral Subtraction (WPSS) filter as an initialization step. The WPSS does a Power Spectral Subtraction (PSS) estimation of the signal spectrum, and combines it with the estimated power spectrum of the previous frame. The filtered signal ŝₚₛₛ(n, k) is then synthesized using the combined spectrum and the noisy phase, and is fed into an LPC analysis (by closing the switch to the WPSS output) to estimate the AR coefficients. A Prediction Error Kalman filter (PEKF) takes the ŝₚₛₛ(n, k) as input and estimates the system noise û(n, k). The time dependent variance of the excitation, σ²ᵤ(n, k), is estimated by a Local Variance Estimator (LVE) that locally smoothes the instantaneous power of the û(n, k). A second Kalman filter then filters the noisy signal to get the final signal estimate, using the estimated SR coefficients and system noise variance. The signal estimate ŝ(n, k) is used by the LPC block in the next iteration (by closing the switch to the feed back link) to improve the estimation of the AR coefficients.

The iterations can be made sequential on a frame-to-frame basis by fixing the number of iterations to one, and closing the switch to the WPSS permanently. This is a frame-wise-sequential approximation to the original iterative algorithm, with the purpose of reducing computational complexity, exploiting the fact that the spectral envelope of the speech signal changes slowly between neighboring frames. As is shown in the experiment section, with an appropriate parameter setting of the WPSS procedure, the iterative algorithm can achieve convergence in the first iteration with an even higher SNR gain. For comparison, the block diagram of the iterative-batch EM approach (IEM) [15][4] that is used as a baseline algorithm in our work is shown in FIG. 2 (A). Note that for the IEM, the system noise variance is only dependent on the frame index k, while for the proposed algorithm, it is dependent on both k and n. The two new functional blocks in the proposed algorithm are the WPSS and the High Temporal Resolution Modeling (HTRM) block. The function of the WPSS is to improve the initialization of the iterative scheme to achieve fast convergence. Section 0.3 addresses the initialization issue in details. The HTRM block estimates the system noise variance in a high temporal resolution, in contrast to the IEM where the system noise variance is constant within a frame. The formulation of the Kalman filtering with high temporal resolution modeling is treated in section 0.4.

Initialization and Sequential Approximation

The Weighted Power Spectral Subtraction procedure combines the signal power spectrum estimated in the previous frame and the one estimated by the Power Spectral Subtraction method in the current frame, so that the iteration of the current frame is started with the result of the previous iteration as well as the new information in the current frame. The weight of the previous frame is set much larger than the weight of the current frame because the signal spectrum envelope varies slowly between neighboring frames. The WPSS combines the spectrum estimates as follows

|{circumflex over (\hat{θ}(k)|²=α|\hat{θ}(k−1)|²+(1−α)max(|Y(k)|²−E[|V(k)|²], 0) (1)

where |{circumflex over (\hat{θ}(k)|² is the estimate of the kth frame's power spectrum at the output of the WPSS, α is the weighting for the previous frame, |\hat{θ}(k−1)|² is the power spectrum of the estimated signal of the previous frame, |Y(k)|² is the power spectrum of the noisy signal, and E[|V(k)|²] is the Power Spectral Density (PSD) of the noise. Here we use bold face letters to represent vectors. The WPSS then takes the square-root of the weighted power spectrum and combines it with the noisy phase to form its output ŝₚₛₛ(n, k). The LPC block uses the ŝₚₛₛ(n, k) to estimate the AR coefficients of the signal.

The WPSS procedure pre-processes the noisy signal so that the iteration starts at a point close to the maximum of the likelihood function, and is thus an initialization procedure. Initialization is crucial to EM approaches. A good initialization can make the convergence faster and prevent converging into a local maxima of the likelihood function. Several authors have suggested using an improved initial estimate of the parameters at the first iteration. In [3], Higher Order Statistics is used in the first estimation of AR parameters in order to improve the immunity to Gaussian noise. In [6], the noisy spectrum is first smoothed before the iteration begins. The initialization that is used here can be understood as using the likelihood maximum found in the previous frame as the starting point in the search of the maximum in the current frame, at the same time adapts to changes by incorporating new information from the PSS estimate. It can also be understood as a smoothed Power Spectral Subtraction method, noting the similarity between (1) and the Decision-Directed method used in [1]. Our experiments show that with this initialization procedure, an EM based approach can achieve faster convergence and higher SNR gain when the a is set appropriately.

Other authors have suggested sequential EM approaches in, e.g. [15] [8] [3] [4] [6]. These methods are sequential on a sample-to-sample basis. Thus the AR coefficients and the residual related parameters need to be estimated at every time instant. Our new algorithm is sequential frame-wise. This reduces computational complexity by exploiting the slow variation of the spectral envelopes (represented by the AR model). The system noise variance, on the other hand, needs a high temporal resolution estimation, and is discussed in the next section.

Kalman Filtering with High Temporal Resolution Signal Model

Speech signals are known as non-stationary. Common practice is to segment the speech into short frames of 10 to 30 ms and assume a certain stationarity within the frame. Thus the temporal resolution of such a quasi-stationarity based processing equals the frame length. For voiced speech, the system noise usually exhibits large power variation within a frame (due to the impulse train structure), thus a much higher temporal resolution is desired. In this work, we allow the variance of the system noise to be indeed time variant. We estimate it by locally smoothing an estimate of the instantaneous power of the system noise.

The Kalman Filtering Solution

We use the following signal model,

$$s ( n ) = {\sum }_{i = 1}^{p} {a}_{i} s ( n - i ) + u ( n ) \\ y ( n ) = s ( n ) + v ( n ) \qquad ( 2 )$$

where the speech signal s(n) is modeled as a pth-order AR process, and y(n) is the observation, αᵢ is the ith AR parameter, the system noise u(n) and the observation noise v(n) are uncorrelated Gaussian processes. The system noise u(n) models the excitation source of the speech signal and is assumed to have a time dependent variance σᵤ²(n) that needs to be estimated. The observation noise variance σᵥ² is assumed to change much slower, such that it can be seen as time invariant in the duration of interest and can be estimated from speech pause. In this work, we further assume that it is known. Equation (2) can be represented by the state space model

x(n)=Ax(n−1)+bu(n)

y(n)=hx(n)+v(n)

where boldface letters represent vectors or matrices. This is a standard state space model for the speech signal. Details about the state vector arrangement and the recursive solution equations are omitted here for brevity. Interested readers are referred to the classic paper [13]. We use the Kalman fixed-lag smoother in our experiment since it obtains the smoothing gain at the expense of delay only (again, see [13]. Though, note that in the proposed algorithm the system noise variance is truly time variant, whereas in the conventional Kalman filtering based speech enhancement the system noise variance is quasi-stationary).

Parameter Estimation

The AR coefficients and the excitation variance should ideally be estimated jointly. However, this turns out to be a very complex problem. Here we also take an iterative approach. The AR coefficients are first estimated as described in Section 0.3, and then the excitation and its rapidly time-varying variance are estimated by the HTRM block, given the current estimate of the AR coefficients. The Kalman filter then uses the current estimate of the AR coefficients and the excitation variance to filter the noisy signal. The spectrum of the filtered signal is used in the next iteration to improve the estimate of the AR coefficients. It is again an approximation to the Maximum Likelihood estimation of the parameters, in which every iteration increases the conditional likelihood of the parameters and the signal.

The time-varying residual variance is estimated by the HTRM block. Given the AR coefficients, a Kalman filter takes the ŝₚₛₛ as input and estimate the system noise, which is essentially the linear prediction error of the clean signal. To distinguish this operation from the second Kalman filter, we call it the Prediction Error Kalman filter (PEKF). Instead of using a conventional linear prediction analysis to find the linear prediction error, we propose to use the PEKF because it has the capability to estimate the excitation source for the clean signal given an explicit model of noise in the observations. Noting that ŝₚₛₛ is the output of a smoothed Power Spectral Subtraction estimator, it contains both remaining noise and signal distortion. We model the joint contribution of the remaining noise and the signal distortion by a white Gaussian noise z(n).

The PEKF thus assumes the following state space model:

x(n)=Ax(n−1)+bu(n)

ŝₚₛₛ(n)=hx(n)+z(n).

Comparing with (3), the differences are: 1) now the ŝₚₛₛ becomes the observation, 2) the system noise u(n) is now modeled as a Gaussian process with constant variance within the frame, 3) the observation noise z(n) has a smaller variance than v(n) because the WPSS procedure has removed part of the noise power. The same Kalman solution as stated before is used to evaluate the prediction, \hat{x}(n|n−1), and the filtered estimation, \hat{x}(n|n). The prediction error is defined as e(n)=\hat{x}(n|n)−\hat{x}(n|n−1). The reason that in the PEKF the system noise variance is modeled as constant within a frame is that we only use it as an initial estimate, and a finer estimate of the time variant variance is obtained at the output of the HTRM block. This is necessary since we can not use the estimate of the σᵤ²(n) in the previous frame as the initialization, due to the fact that the proposed processing framework is not pitch-synchronous. We assume z(n) to be zero-mean Gaussian with variance σ_{z}²=βσᵥ² where β is a fractional scalar determined by experiments.

The high temporal resolution estimate of the system noise variance σᵤ²(n) is obtained by local smoothing of the instantaneous power of ε(n). By a moving average smoothing using 2 or 3 points at each side of the current data point we get a quite good result. However, we found that a cubic spline smoothing yields better performance. The reason could be that the spline smoothing smoothes more in the valleys between two impulses than at the impulse peaks because of the large difference between the amplitudes of the impulse and the noise floor. This property of spline smoothing is desirable for our purpose since we want to maintain the dynamic range of the impulse as much as possible while smoothing out noise in the valleys. The cubic spline smoothing is implemented using the Matlab routine csaps with the smoothing parameter set to 0.1.

Experiments and Results

We first define three objective quality measures used in this section, i.e., the signal to noise ratio (SNR), segmental SNR (segSNR), and Log-Spectral Distortion (LSD). The SNR is defined as the ratio of the total signal power to the total noise power in the utterance. SNR provides a simple error measure although its suitability for perceptual quality measure is questioned since it equally weights the frames with different energy while noise is known to be especially disturbing in low energy parts of the speech. We mainly use SNR as a convergence measure. Segmental SNR is defined as the average ratio of signal power to noise power per frame, and is regarded to be better correlated with perceptual quality than the SNR. The LSD is defined as the distance between two log-scaled DFT spectra averaged over all frequency bins [14]. We measure the LSD on voiced frames only. Common parameters are set as follows: the sampling frequency is 8 kHz, the AR model order is 10, the frame length is 160 samples. We aim at removing broad band noise from speech signals. In the experiments, the speech is contaminated by computer generated white Gaussian noise. The algorithm can be easily extended for the colored noise by augmenting the signal state vector and the transition matrix with the ones of the noise [5].

TABLE 1
Output SNR of IEM + WPSS at different α and IEM.

| | α | | | | | | | | |
|---|---|---|---|---|---|---|---|---|---|
| Iter. | 0.0 | 0.8 | 0.9 | 0.95 | 0.96 | 0.97 | 0.98 | 0.99 | IEM |
| 1 | 9.45 | 10.39 | 10.86 | 11.22 | 11.31 | 11.38 | 11.41 | 11.33 | 10.36 |
| 2 | 10.57 | 11.07 | 11.26 | 11.36 | 11.37 | 11.37 | 11.33 | 11.21 | 11.06 |
| 3 | 10.94 | 11.12 | 11.20 | 11.22 | 11.22 | 11.20 | 11.17 | 11.06 | 11.17 |
| 4 | 10.99 | 11.06 | 11.09 | 11.09 | 11.08 | 11.07 | 11.05 | 10.97 | 11.11 |

We then compare the performance of the IBM with and without WPSS initialization, in order to show the effectiveness of the WPSS initialization. The two system configurations are as in FIG. 2. When it is without the WPSS, the IEM is initialized by estimating the AR coefficients from the noisy signal. In the original IBM [15], the observation noise variance is estimated iteratively as part of the EM estimation and the system noise variance is obtained from the variance of the LPC residual. In this work, the observation noise variance is estimated from the speech pause. Utilizing this information, for the IEM, the initial estimate of the system noise variance is obtained by subtracting the noise variance from the LPC residual variance. We found that this modification improves the SNR gains by about 2 dB. In the sequel, we refer to the modified version as the IEM. Table 1 shows the output SNR of the IEM with WPSS initialization (IEM+WPSS) at different α and the IEM versus the number of iterations. The input signal is 3.6 seconds of male speech corrupted by white Gaussian noise at 5 dB SNR. By the SNR measure, the IEM converges at the third iteration. While for the IEM+WPSS, the iteration of convergence is dependent of α. When α is greater than 0.96, the algorithm achieves convergence at the first iteration. With a larger than 0.98 the SNR improvement decreases. Experiments on more speech samples and SNR levels show a consistent trend. Thus the α is decided to be 0.98. The result shows that the IEM with WPSS initialization (α=0.98) can achieve convergence at the first iteration and obtain even higher SNR gain than the IBM with three iterations.

Next, to determine the values of the weighting factor α and the remaining-noise-factor β for the proposed iterative Kalman filtering (IKF) algorithm, the algorithm is applied to 16 sentences from the TIMIT corpus added with white Gaussian noise at 5 dB SNR with various values of α and β. As is for the IEM+WPSS, the number of iterations needed for convergence of IKF is dependent of the parameters. The combination of α and β that makes convergence at the first iteration and gives the best result is chosen. By balancing the noise reduction and signal distortion, we choose the combination: α=0.95, β=0.5.

It is observed in this experiment that for an a smaller than 0.98, setting β to α value larger than 0 results in a great improvement in the SNR, segSNR, and LSD, in comparison to when β is 0. Note that when β equals 0, the PEKF is reduced to the conventional linear prediction error filter. This suggests that the prediction-error Kalman filter succeeds in modeling and reducing the remaining noise in the excitation ID source that can not be modeled by the linear prediction error filter. When the α is larger than 0.98, setting β to a positive value does not improve the SNR and LSD, but still significantly improves the segSNR.

Now we compare the IKF with the base line IEM, and the IEM+WPSS algorithm. The results averaged on 30 TIMIT sentences (the training set used in the parameter selection is not included) are listed in Table 2. Significant improvement in all the three performance measures is observed, especially the segmental SNR. The only exception is the LSD at 0 dB. To confirm the subjective quality improvement, we apply a Degradation Mean Opinion Score (DMOS) test on the enhanced speech by the IKF and IEM, with 10 untrained listeners. The result is shown in Tab 3. The listening test reveals that the background noise level in the IKF output is perceived to be significantly lower than the IEM. Besides, the low score of IBM is attributed to the annoying musical artifact, which is greatly reduced in the IKF. At input SNR higher than 15 dB, the background noise in the IKF enhanced speech is reduced to almost inaudible without introducing any major artifact.

### CONCLUSION

In this paper, a new iterative Kalman filtering based speech enhancement scheme is presented. It is an approximation to the EM algorithm embracing the maximum likelihood principle. A high temporal resolution signal model is used to model voiced speech and the rapidly varying variance of the excitation source is estimated by

TABLE 2
Performance comparison. White Gaussian noise.

| Input | Methods | SNR[dB] | segSNR[dB] | LSD[dB] |
|---|---|---|---|---|
| 20 dB | IKF | 23.13 | 12.60 | 1.89 |
| | IEM + WPSS | 22.75 | 11.42 | 2.08 |
| | IEM | 22.72 | 11.61 | 2.07 |
| 15 dB | IKF | 19.16 | 9.48 | 2.46 |
| | IEM + WPSS | 18.74 | 7.79 | 2.68 |
| | IEM | 18.69 | 8.13 | 2.65 |
| 10 dB | IKF | 15.37 | 6.65 | 3.15 |
| | IEM + WPSS | 14.96 | 4.36 | 3.33 |
| | IEM | 14.85 | 4.76 | 3.30 |
| 5 dB | IKF | 11.71 | 4.07 | 4.06 |
| | IEM + WPSS | 11.40 | 1.13 | 3.96 |
| | IEM | 11.18 | 1.56 | 3.97 |
| 0 dB | IKF | 8.25 | 1.81 | 5.24 |
| | IEM + WPSS | 8.11 | −1.95 | 4.54 |
| | IEM | 7.81 | −1.44 | 4.67 |

TABLE 3
DMOS scores.

| | | | | | | | | |
|---|---|---|---|---|---|---|---|---|
| 15 dB | IKF | 3.92 | 10 dB | IKF | 3.12 | 5 dB | IKF | 2.14 |
| | IEM | 2.25 | | IEM | 1.98 | | IEM | 1.64 |
| | noisy | 2.11 | | noisy | 1.79 | | noisy | 1.63 |

a prediction-error Kalman filter. Distinct from other algorithms utilizing fine models for voiced speech, this approach avoids any voiced/unvoiced decision and pitch related parameter estimation. The convergence of the algorithm is obtained at the first iteration by introducing the WPSS initialization procedure. Performance evaluation shows significant improvements in three objective measures. Furthermore, informal listening indicates a significant reduction of musical noise. This result is confirmed by a DMOS subjective test.

### REFERENCES

[1] Y. Ephraim and D. Malah. Speech Enhancement Using a Minimum Mean-Square Error Log-Spectral Amplitude Estimator. IEEE Trans. on Acoustics, Speech, and Signal Processing, ASSP-33:443-445, April 1985.
[2] M. Feder, A. V. Oppenheim, and E. Weinstein. Maximum likelihood noise cancellation using the EM algorithm. IEEE Trans. on Acoustic, Speech and Signal Processing, 37, no. 2:204-216, 1989.
[3] S. Gannot. Algorithms for single microphone speech enhancement. M.Sc. thesis, Tel-Auiv University, April 1995.
[4] S. Gannot, D. Burshtein, and E. Weinstein. Iterative and sequential Kalman filter-based speech enhancement algorithms. IEEE Trans. on Speech and Audio, 6:373-385, July 1998.
[5] J. D. Gibson, B. Koo, and S. D. Gray. Filtering of colored noise for speech enhancement. IEEE Trans. on Signal Processing, 39:1732-1742, 1991.
[6] Z. Goh, K. Tan, and B. T. G. Tan. Kalman filtering speech enhancement method based on a voiced-unvoiced speech model. IEEE Trans. on Speech and Audio Processing, 7, No. 5:510-524, 1999.
[7] J. H. L. Hansen and M. A. Clements. Constrained Iterative Speech Enhancement with Application to Speech Recognition. IEEE Trans. Signal Processing, 39:795-805, 1991.
[8] B. G. Lee, K. Y. Lee, and S. Ann. An EM-based approach for parameter enhancement with an application to speech signals. Signal Processing, 46:1-14, 1995.
[9] C. Li and S. V. Andersen. Integrating Kalman filtering and multi-pulse coding for speech enhancement with a non-stationary model of the speech signal. Proceedings of the 38th Asilomar Conference on Signals, Systems, and Computers, June 2004.
[10] C. Li and S. V. Andersen. Inter-frequency Dependency in MMSE Speech Enhancement. Proceedings of the 6th Nordic Signal Processing Symposium, June 2004.
[11] C. Li and S. V. Andersen. A block based linear MMSE noise reduction with a high temporal resolution modeling of the speech excitation. to appear in EURASIP Journal on Applied Signal Processing, 2005.
[12] J. S. Lim and A. V. Oppenheim. All-pole Modeling of Degraded Speech. IEEE Trans. Acoust., Speech, Signal Processing, ASP-26:197-209, June 1978.
[13] K. K. Paliwal and Anjan Basu. A Speech Enhancement Method Based on Kalman Filtering. Proc. of ICASSP 1987, 12:177-180, April 1987.
[14] S. R. Quackenbush, T. P. Barnwell, and M. A. Clements. Objective Measures of Speech Quality. Prentice Hall, 1988.
[15] E. Weinstein, A. V. Oppenheim, and M. Feder. Signal enhancement using single and multi-sensor measurements. RLE Tech. Rep. 560, MIT, Cambridge, Mass., 46:1-14, 1990.

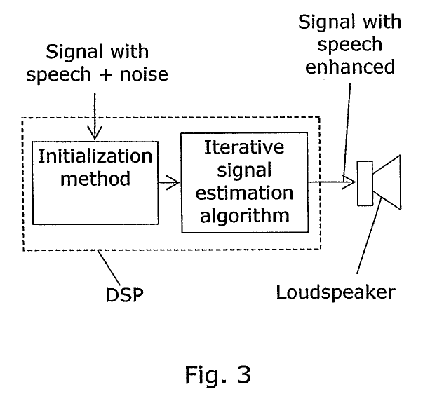

FIG. 3 illustrates a block diagram of a preferred device embodiment. The illustrated device may be such as a mobile phone, a headset or a part thereof. The device is adapted to receive a noisy signal, e.g. an electrical analog or digital signal representing an audio signal containing speech and unintended noise. The device includes a digital signal processor DSP that performs a signal processing on the noisy signal. First, an initialization method is performed, including a non-parametric noise reduction, such as described in the foregoing. The initialization method serves as input to an Iterative signal estimation algorithm, e.g. an EM type algorithm as also described in the foregoing. The output of the signal estimation algorithm is a signal where the speech is enhanced in relation to the noise. This signal with enhanced speech is applied to a loudspeaker, preferably via an amplifier, so as to present an acoustic representation of the speech enhanced signal to a listener.

As mentioned, the device in FIG. 3 may be a hearing aid, a headset or a mobile phone or the like. In case of a headset, the DSP may either be built into the headset, or the DSP may be positioned remote from the headset, e.g. built into other equipment such as amplifier equipment. In case of a hearing aid, the noisy signal can originate from a remote audio source or from microphone built into the hearing aid.

Even though the described embodiments are concerned with audio signals, it is appreciated that principles of the methods described can be used for a large variety of applications for audio signals as well as other types of noisy signals.

It is to be understood that reference signs in the claims should not be construed as limiting with respect to the scope of the claims.

1. A signal estimation algorithm for a signal (y(n,k)) corrupted by additive noise comprising, a source-filter model, wherein estimation of the source comprises a prediction error Kalman filtering (PEKF).

2. The signal estimation algorithm according to claim 1, wherein the algorithm includes a local variance estimation (LVE).

3. The signal estimation algorithm according to claim 2, wherein the prediction error Kalman filtering (PEKF) is followed by the local variance estimation (LVE).

4. The signal estimation algorithm according to claim 1, further comprising an initialization, wherein the initialization comprises a non-parametric noise reduction method.

5. The signal estimation algorithm according to claim 4, wherein the non-parametric noise reduction method comprises a spectral subtraction.

6. The signal estimation algorithm according to claim 5, wherein the spectral subtraction is a power spectral subtraction.

7. The signal estimation algorithm according to claim 6, wherein the power spectral subtraction method is a weighted power spectral subtraction (WPSS).

8. The signal estimation algorithm according to claim 1, wherein the signal estimation algorithm is an iterative signal estimation algorithm.

9. The signal estimation algorithm according to claim 8, wherein the iterative signal estimation algorithm comprises an expectation-maximization algorithm.

10. The signal estimation algorithm according to claim 8, wherein the iterative signal estimation algorithm comprises a Kalman filtering.

11. The signal estimation algorithm according to claim 8, comprising only one iteration of the iterative signal estimation algorithm in each frame.

12. A noise reduction method comprising:
performing the signal estimation algorithm according to claim 1, and
providing a noise suppressed signal (ŝ(n,k)) based on an output from the signal estimation algorithm.

13. A speech enhancement method comprising performing the noise reduction method according to claim 12 on a noisy signal (y(n,k) containing speech so as to enhance the speech.

14. A device comprising a processor adapted to perform the method of claim 12.

15. The device according to claim 14, wherein said device is selected from the group consisting of:
a mobile phone, a radio communication device, an internet telephony system, sound recording equipment, sound processing equipment, sound editing equipment, broadcasting sound equipment, and a monitoring system.

16. The device according to claim 14, wherein said device is selected from the group consisting of:
a hearing aid, a headset, an assistive listening device, an electronic hearing protector, and a headphone with a built-in microphone.

17. A computer executable program code adapted to perform the method according to claim 12.
